(19) United States
(12) Patent Application Publication
(10) Pub. No.: US 2019/0088192 A1
(43) Pub. Date: Mar. 21, 2019

(54) DISPLAY DEVICE AND DRIVING METHOD THEREOF

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Zijiao XUE, Beijing (CN); Lingyun SHI, Beijing (CN); Wei SUN, Beijing (CN); Guangquan WANG, Beijing (CN); Dong CHEN, Beijing (CN); Bo GAO, Beijing (CN)

(21) Appl. No.: 15/767,729

(22) PCT Filed: Sep. 30, 2017
(86) PCT No.: PCT/CN2017/104707

§ 371 Date: Apr. 12, 2018

(30) Foreign Application Priority Data
Jan. 17, 2017 (CN) 201710036309.X

(51) Int. Cl. G09G 3/22

(52) U.S. Cl. CPC G09G 3/22; G09G 2360/12; G09G 2310/08

(57) ABSTRACT

A display device and a driving method for the same are disclosed. The display device includes a display panel, a data transmitter, a driver integrated circuit and a random access memory, the data transmitter is used for transmitting display data to the random access memory at a first rate in one frame period of time, the one frame period of time comprising a scanning period of time and a display period of time, and the driver integrated circuit is used for reading the display data from the random access memory at a second rate and transmitting it to the display panel in the scanning period of time.

### RELATED APPLICATION

The present application is the U.S. national phase entry of PCT/CN2017/104707, with an international filing date of Sep. 30, 2017, which claims the benefit of Chinese Patent Application No. 201710036309.X, filed on Jan. 17, 2017, the entire disclosures of which are incorporated herein by reference.

### TECHNICAL FIELD

The disclosure relates to the field of display technology, and in particular, to a display device and a driving method for the same.

### BACKGROUND

In a reference, as shown in FIG. 1, a display device comprises a display panel 11, a data transmitter 21 and a driver integrated circuit 22. The data transmitter 21 is used for transmitting display data to the driver integrated circuit 22 at a certain data transmission rate within one frame period of time, to be transmitted to the display panel by the driver integrated circuit 22 for display.

The existing data transmission rate cannot match the amount of data or frame frequency of a high resolution display screen, and will constitute a bottleneck to improve the display effect of the display device.

### SUMMARY

A display device provided by an embodiment of the disclosure comprises a display panel, a data transmitter, a driver integrated circuit and a random access memory, the data transmitter is used for transmitting display data to the random access memory at a first rate in one frame period of time, the one frame period of time comprising a scanning period of time and a display period of time, and the driver integrated circuit is used for reading the display data from the random access memory and transmitting it to the display panel in the scanning period of time.

data transmitterdata transmitterdata transmitterdata transmitter In particular, the display device further comprises a light source for providing the display panel with backlight in the display period of time. As such, backlight black insertion is done while the data acquisition efficiency is increased, and improvement of user's viewing discomfort is realized.

In particular, the random access memory is integrated into the driver integrated circuit.

In particular, the random access memory is coupled to the data transmitter via a mobile industry processor interface MIPI.

In particular, the random access memory comprises a dynamic random access memory. may

In particular, the display device comprises a virtual reality display device.

An embodiment of the disclosure further provides a driving method for a display device, the display device comprises a display panel, a data transmitter, a driver integrated circuit and a random access memory, and the method comprises: the data transmitter transmitting display data to the random access memory at a first rate in one frame period of time from a first moment, the one frame period of time comprising a scanning period of time and a display period of time, and the driver integrated circuit reading the display data from the random access memory at a second rate and then transmitting it to the display panel in the scanning period of time from a second moment, wherein the first moment is earlier than the second moment, and the difference between the second moment and the first moment does not exceed one frame period of time.

In particular, the display device further comprises a light source, and the driving method further comprises: turning off the light source in the scanning period of time, and turning on the light source in the display period of time.

In particular, the random access memory is integrated into the driver integrated circuit.

In particular, the first rate follows the mobile industry processor interface MIPI protocol.

In particular, the random access memory comprises a dynamic random access memory.

In particular, the display device comprises a virtual reality display device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. In addition, the claimed subject matter is not restricted to implementations that solve any or all of the disadvantages mentioned in any part of the disclosure.

### BRIEF DESCRIPTION OF THE DRAWINGS

FIG. 1 is a block diagram of a reference display device.

FIG. 2 is a block diagram of a display device provided by an embodiment of the disclosure.

FIG. 3 is a work process of a display device in combination with a frame period of time provided by an embodiment of the disclosure.

FIG. 4 is a flow chart of a driving method for a display device provided by an embodiment of the disclosure.

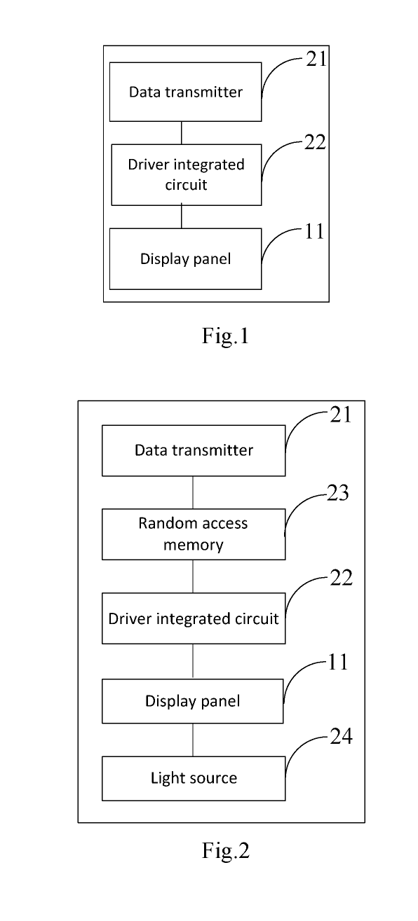

### DETAILED DESCRIPTION

Embodiments of the disclosure provide a display device and a driving method for the same so as to improve the acquisition efficiency of display data.

To make the objectives, technical solutions and advantages of the disclosure clearer, the disclosure will be further described in detail in connection with the drawings in the following. Obviously, the described embodiments are just a part of the embodiments of the disclosure, and not all of the embodiments. Based on the embodiments in the disclosure, all the other embodiments obtained by those of ordinary skills in the art under the premise of not paying out creative work pertain to the scope protected by the disclosure.

In the following, a display device provided by a specific embodiment of the disclosure will be introduced in detail in connection with the drawings.

As shown in FIG. 2, a specific embodiment of the disclosure provides a display device comprising a display panel 11, a data transmitter 21, a driver integrated circuit 22 and a random access memory 23, the data transmitter 21 is used for transmitting display data to the random access memory at a first rate in one frame period of time, the one frame period of time comprising a scanning period of time and a display period of time, the random access memory 23 is used for receiving and storing the display data, and the driver integrated circuit 22 is used for reading the display data from the random access memory at a second rate and then transmitting it to the display panel in the scanning period of time.

The display device in the specific embodiment of the disclosure comprises the random access memory. At this point, its data transmitter does not conduct display data transmission directly with its driver integrated circuit which drives the display panel for display any longer, but first transmits display data to its random access memory for storage, and then its driver integrated circuit reads the display data from the random access memory in the scanning period of time comprised in one frame period of time and drives the display panel for display according to the display data. Since as compared to the data transmitter, the random access memory may read and write at any time, and the speed is very high and far more than the transmission rate of the data transmitter, which may better match the amount of data or frame frequency of a high resolution display screen when the resolution of the display device is high. The data transmitter in the specific embodiment of the disclosure may continuously transmit data in one frame period of time of the display panel, and when employing the backlight black insertion, the transmission of display data may be conducted at a lower rate, however, one frame period of time may be fully utilized for the transmission of the display data, as compared with that the reference can only transmit the display data in the scanning period of time. Therefore, suppose that when employing the backlight black insertion, the specific embodiment of the disclosure and the reference use the same data transmission rate, the driver integrated circuit of the specific embodiment of the disclosure may acquire more display data in the scanning period of time, namely, the acquisition efficiency of display data is increased.

In particular, the display device further comprises a light source 24 for providing the display panel with backlight in the display period of time.

In particular, the display device in the specific embodiment of the disclosure is a virtual reality display device.

As compared to the reference, since the driver integrated circuit in the specific embodiment of the disclosure reads the display data from the random access memory in the scanning period of time comprised in one frame period of time, the light source of the display device in the specific embodiment of the disclosure may be turned off in the scanning period of time comprised in one frame period of time, that is, enough backlight off time may be reserved, and improvement of user's discomfort at the time of viewing is realized.

In particular, the random access memory in the specific embodiment of the disclosure is integrated into the driver integrated circuit 22 for driving the display panel, and of course, in the actual production process, the random access memory may also be set on a driver chip which is set separately, and the specific setting position of the random access memory will not be defined by the specific embodiment of the disclosure.

In particular, the random access memory in the specific embodiment of the disclosure is coupled to the data transmitter via a mobile industry processor interface (MIPI), that is, the first rate follows the mobile industry processor interface (MIPI) protocol, the first rate being less than the second rate. The data transmission rate under the MIPI protocol=the amount of data/the number of sets of data channels. The amount of data=the horizontal resolution of the display screen×the vertical resolution of the display screen×the frame frequency×24. According to the MIPI protocol, the transmission speed of a set of data channels supports a data transmission rate of up to 1 Gbps (1000 Mbps).

In particular, the random access memory in the specific embodiment of the disclosure comprises a dynamic random access memory, of which the degree of integration is high, the power consumption is low and the price is low. Of course, in the actual production process, the random access memory in the specific embodiment of the disclosure may also comprise a static random access memory. The read and write frequency of the RAM is generally in 100-200 MHz, however, the number of data bits it reads each time may be adjusted (8 bits, 16 bits, etc.). Suppose that the read and write frequency of the RAM is 200 MHz, it may read and write 200M times per second. If it may read and write 8 bits each time, its rate is 1600 Mbps, and if it may read and write 16 bits each time, the second transmission rate is 3200 Mbps.

It may be appreciated that the first rate may be fixed, alternatively may be variable, which depends the transmission mechanism, and alternatively setting.

It may be appreciated that the scanning period of time discussed herein only refers to a period of time in which the display data is scanned.

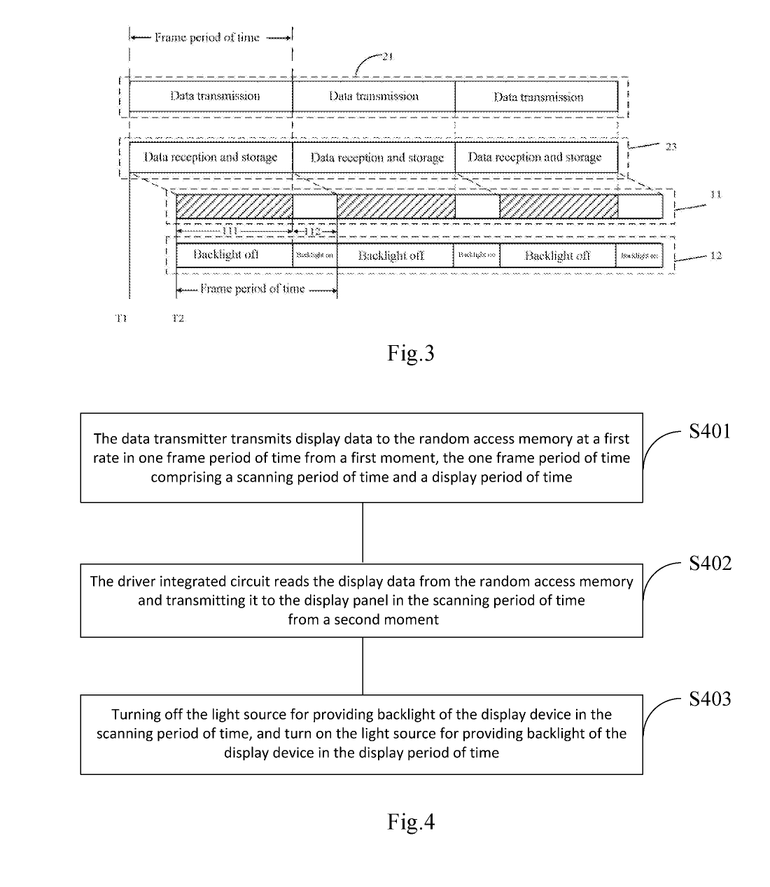

In the following, the specific embodiment of the disclosure will be introduced in detail in conjunction with FIG. 3 and FIG. 4.

FIG. 3 illustrates a work process of a display device according to an embodiment of the disclosure in combination with a frame period of time, and FIG. 4 shows a driving method for a display device according to an embodiment of the disclosure.

FIG. 3 illustrates 3 frame periods of time. In the first row, the data transmission is performed by the data transmitter 21, it is transmitted to the random access memory 23, and meanwhile, the random access memory 23 receives and stores the data transmitted by the data transmitter 21. For the sake of brevity, the transmission, reception and storage of data is illustrated as starting at a first moment T1. In fact, it may be appreciated by the skilled in the art that there is a time difference between the transmission of data and the reception and storage of the data, and the time difference is a transmission delay. However, since the delay is very small, it will be ignored herein. The transmission delay is determined by the transmission rate, and the transmission rate may be fixed, and alternatively may be variable, which particularly depends on the connection mechanism between the random access memory 23 and the data transmitter 21.

After having the display data, the random access memory 23 may start to provide the display data to the display panel at a second moment T2, which is performed by the driver integrated circuit 22. The second moment T2 is behind the first moment T1.

It may be appreciated that the first rate is less than the second rate, and it is also necessary to ensure that the display panel receives all the display data in the scanning period of time. In an example, as shown in FIG. 3, if the data transmitter 21 needs to utilize time of one whole frame (e.g., 16.6 ms) so as to be able to transmit all the display data of the frame to the random access memory 23, and yet the driver integrated circuit 22 needs time of e.g. 6.6 ms to be able to fully read the display data from the random access memory 23, and it may be appreciated that the end moment of the 6.6 ms will not be earlier than that of the 16.6 ms in which the data transmitter 21 transmits the data to the random access memory, then the second moment may be at least 10 ms later than the first moment. Other examples are also possible. If the data transmitter 21 only needs to utilize part of the time of one whole frame (e.g., 8 ms in 10 s) to be able to transmit all the display data of the frame to the random access memory 23, and yet the driver integrated circuit 22 needs time of e.g. 5 ms to be able to fully read the display data from the random access memory 23, then the second moment may be at least 3 ms later than the first moment. In these examples, the difference between the second moment T2 and the first moment T1 does not exceed one frame period of time. The difference between the second moment T2 and the first moment T1 is not limited to the above examples, and may be appropriately set as needed. For example, if delay is allowed, the second moment T2 and the first moment T1 may absolutely differ by more than one frame period of time.

In an embodiment, the backlight black insertion technique is utilized for display. That is, in one frame period of time of the display panel 11, the light source 24 for providing the backlight is turned off during the scanning period of time 111, whereas the light source 24 for providing the backlight is turned on during the display period of time 112. The reference backlight black insertion operation is equivalent to compressing the data transmission time of the display device, however, with the occurrence of the requirement for a high resolution for a VR display system, the reference cannot break through its limitation and meet this requirement. However, according to our embodiments, the data transmitter 21 may transmit data to the random access memory 23 at any moment, including that it may transmit data in the entire frame period of time, reading data from the random access memory is fairly fast, and therefore, the requirement for the amount of data for high-definition display by employing the backlight black insertion operation cannot constitute an adverse effect.

The driving method shown in FIG. 4 comprises:

S401, the data transmitter 21 transmitting display data to the random access memory 23 at a first rate in one frame period of time from a first moment T1, the one frame period of time comprising a scanning period of time and a display period of time.

S402, the driver integrated circuit 22 reading the display data from the random access memory 23 at a second rate and transmitting it to the display panel 11 in the scanning period of time from a second moment T2.

alternatively or optionally, S403, turning off the light source 24 for providing backlight of the display device in the scanning period of time 111, and turning on the light source 24 for providing backlight of the display device in the display period of time 112.

The order in which the above method steps are described does not represent their order of time, and they may appear in any appropriate order.

Therein, with reference to FIG. 3, the first moment T1 is earlier than the second moment T2, and in particular, as can be seen, the difference between the second moment T2 and the first moment T1 does not exceed one frame period of time.

In particular, the display device of the specific embodiment of the disclosure comprises a virtual reality display device.

In particular, the data transmitter of the specific embodiment of the disclosure transmitting display data to the random access memory in one frame period of time comprises: the data transmitter transmitting the display data to the random access memory via a mobile industry processor interface (MIPI) in the one frame period of time.

In particular, the random access memory of the specific embodiment of the disclosure is integrated into the driver integrated circuit, which random access memory comprises a dynamic random access memory.

In summary, the specific embodiments of the disclosure provide a display device and a corresponding driving method. The display device comprises a display panel, a data transmitter, a driver integrated circuit and a random access memory, the data transmitter is used for transmitting display data to the random access memory at a first rate in one frame period of time, the one frame period of time comprising a scanning period of time and a display period of time, and the driver integrated circuit is used for reading the display data from the random access memory and transmitting it to the display panel in the scanning period of time. Since the display device in the specific embodiments of the disclosure comprises the random access memory, as compared with the reference, its data transmitter does not conduct data transmission directly with its driver integrated circuit any longer, but first transmits display data to its random access memory for storage, and then its driver integrated circuit reads the display data from the random access memory in the scanning period of time comprised in one frame period of time. Since as compared to the data transmitter, the random access memory may read and write at any time, and the speed is higher, which may well match the amount of data or frame frequency of a high resolution display screen when the resolution of the display device is high. The data transmitter in the specific embodiments of the disclosure may continuously transmit data in one frame period of time of the display panel, and when employing the backlight black insertion, it is unnecessary to conduct the transmission of data at too fast a rate, however, one frame period of time may be fully utilized for the transmission of the display data, as compared with that the reference may only transmit the display data in the scanning period of time. Therefore, suppose that when employing the backlight black insertion, the embodiments of the disclosure and the reference use the same data transmission rate, the driver integrated circuit of the specific embodiments of the disclosure may acquire more display data in the scanning period of time, namely, the acquisition efficiency of data is increased. The backlight black insertion may further be conducted while the acquisition efficiency of data is increased, which also further realizes the improvement of user's discomfort at the time of viewing.

Clearly, various modifications and variations may be made to the disclosure by the skilled in the art without departing from the spirit and scope of the disclosure. As such, the disclosure is also intended to include these modifications and variations, if the modifications and variations of the disclosure pertain to the scope of the claims of the disclosure and the equivalence thereof.

1. A display device comprising a display panel, further comprising a data transmitter, a driver integrated circuit and a random access memory,
the data transmitter being used for transmitting display data to the random access memory at a first rate in one frame period of time, the one frame period of time comprising a scanning period of time and a display period of time, and
the driver integrated circuit being used for reading the display data from the random access memory at a second rate and then transmitting it to the display panel in the scanning period of time.

2. The display device as claimed in claim 1, further comprising a light source for providing the display panel with backlight in the display period of time.

3. The display device as claimed in claim 1, wherein the random access memory is integrated into the driver integrated circuit.

4. The display device as claimed in claim 1, wherein the random access memory is coupled to the data transmitter via a mobile industry processor interface (MIPI).

5. The display device as claimed in claim 1, wherein the random access memory comprises a dynamic random access memory.

6. The display device as claimed in claim 1, wherein the display device comprises a virtual reality display device.

7. A driving method for a display device, the display device comprising a display panel, a data transmitter, a driver integrated circuit and a random access memory, and the method comprising:
the data transmitter transmitting display data to the random access memory at a first rate in one frame period of time from a first moment, the one frame period of time comprising a scanning period of time and a display period of time, and
the driver integrated circuit reading the display data from the random access memory at a second rate and then transmitting it to the display panel in the scanning period of time from a second moment,
wherein the first moment is earlier than the second moment.

8. The driving method as claimed in claim 7, wherein the difference between the second moment and the first moment does not exceed one frame period of time.

9. The driving method as claimed in claim 7, wherein the display device further comprises a light source, and the driving method further comprises:
turning off the light source in the scanning period of time, and turning on the light source in the display period of time.

10. The method as claimed in claim 7, wherein the random access memory is integrated into the driver integrated circuit.

11. The method as claimed in claim 7, wherein the first rate follows the mobile industry processor interface (MIPI) protocol, and the first rate is less than the second rate.

12. The method as claimed in claim 7, wherein the random access memory comprises a dynamic random access memory.

13. The method as claimed in claim 7, wherein the display device comprises a virtual reality display device.
